(19) United States
(12) Patent Application Publication
(10) Pub. No.: US 2026/0241350 A1
(43) Pub. Date: Aug. 20, 2026

(54) DUAL MATERIAL MIXING BLADES AND METHODS OF ATTACHMENT

(71) Applicant: Tesla, Inc., Austin, TX (US)

(72) Inventors: Kevin Cornelius Matthews, San Francisco, CA (US); Shamali Laxman Nevase, Fremont, CA (US); Joseph Michael Weissig, Fullerton, CA (US)

(21) Appl. No.: 19/058,910

(22) Filed: Feb. 20, 2025

(51) Int. Cl. B01F 27/052; B01F 23/60; B01F 27/053; B01F 27/112; B01F 27/906; B01F 35/12; H01M 4/04

(52) U.S. Cl. CPC B01F 27/052; B01F 23/60; B01F 27/053; B01F 27/0531; B01F 27/112; B01F 27/906; B01F 35/12; H01M 4/04; B01F 2215/0486

(57) ABSTRACT

Mixing blades including a replaceable mixing blade tip and an attachment element are described, and methods, systems, and devices thereof. The replaceable mixing blade tip may be utilized in mixing dry electrode film mixtures, and therefore the wear resistance of the mixing blade may be improved along with reducing the time and/or cost of replacing worn components.

### BACKGROUND

### Field

The present disclosure relates generally to a mixing blade, particularly a mixing blade for mixing dry electrode powders.

### Description of the Related Art

Electrode films can be formed from wet or dry processes. In wet or slurry-based electrode film forming processes, a slurry is mixed, coated on a foil and, dried onto the foil. The mixing of the slurry often does not require high speed mixing, and the liquid components of the slurry reduce the abrasiveness of the slurry on mixing elements. In dry electrode film forming processes, a dry electrode powder is mixed, and then calendered onto a foil. Dry electrode powders can require high shear particle mixing to form a mixed dry electrode material. The high shear missing can reduce particle size, create fibrillization of binder materials and/or coat particles, which in turn can improve the quality of the electrode film created with the dry electrode powder.

The components of dry electrode powders can be dry and abrasive. This can cause excessive wear on the blades used to mix dry electrode powders. Excessive wear on mixing blades can result in frequent blade replacement, which is time consuming and expensive, and can also result in dry electrode powder contamination due to the wear on the mixing blades. Accordingly, there is a need for improved mixing blades.

### SUMMARY

For purposes of summarizing the invention and the advantages achieved over the prior art, certain objects and advantages of the invention are described herein. Not all such objects or advantages may be achieved in any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

In one aspect, a mixer is described. The mixer comprises a dry electrode film mixture comprising an active material and a carbon material, a mixing blade, and a mixing container, where the dry electrode film mixer and the mixing blade are positioned within the mixing container, and where the mixing blade is configured to high shear process the dry electrode film mixture. The mixing blade comprises a base blade comprising a steel base material, and a first leading edge and extending in a first direction, a solid carbide blade tip positioned at an end of the base blade and extending over a portion of the first leading edge, and an attachment element configured to removably attach the blade tip to the base blade.

In one aspect, a mixing blade device is described. The mixing blade device comprises a base blade comprising a base material, a blade tip, comprising a wear-resistant material, and an attachment element configured to attach the blade tip to the base blade, wherein the first material is different than the wear-resistant material.

In some embodiments, the wear-resistant material comprises solid carbide. In some embodiments, the base material comprises steel. In some embodiments, the attachment element is selected from the group consisting of a pin, a post, a bolt, a dovetail, a tensioning element, and combinations thereof. In some embodiments, the base blade further comprises the attachment element. In some embodiments, the base blade further comprises an upper blade portion and a lower blade portion. In some embodiments, the attachment element is positioned between the upper blade portion and the lower blade portion. In some embodiments, the wear-resistant material has a compressive strength greater than 4000 MPa. In some embodiments, the wear-resistant material has a yield strength of greater than 1200 MPa. In some embodiments, the blade tip material volume loss wear rate at 90-degrees impact (i.e., erosion) 2 mm³. In some embodiments, the blade tip material volume loss wear rate at 22.5-degree impact is less than about 1 mm³.

In one aspect, a mixing blade device is described. The mixing blade device comprises a base blade comprising a base material, a first blade tip disposed at a first end of the base blade, a first attachment element configured to attach the first blade tip to the base blade, a second blade tip disposed at a second end of the base blade, and a second attachment element configured to attach the second blade tip to the base blade.

In some embodiments, the wear-resistant material comprises solid carbide. In some embodiments, the mixing blade device comprises a spray coating. In some embodiments, the spray coating is positioned over at least one of the leading edge of the blade tip, and a leading edge of the base blade. In some embodiments, the spray coating comprises polytetrafluoroethylene (PTFE). In some embodiments, a method of replacing a mixing blade tip is described. The method comprises providing a mixing blade device as described herein, removing the blade tip from the base blade, and attaching a new blade tip to the base blade. In some embodiments, a mixing apparatus is described. The mixing apparatus comprises one or more mixing blade devices as described herein, and a mixer. In some embodiments, the mixer is a fluidized bed mixer.

### BRIEF DESCRIPTION OF THE DRAWINGS

The present inventions are described with reference to the accompanying drawings, in which like reference characters reference like elements, and wherein:

FIG. 1 is a schematic top view illustration of a mixing blade with an attachment mechanism including a fastener according to some embodiments.

FIG. 2 is a schematic top view illustration of a base blade, according to some embodiments.

FIG. 3 is a schematic perspective view illustration of a blade tip, according to some embodiments.

FIG. 4A is a schematic exploded perspective view illustration of a mixing blade with an attachment mechanism including a tapered dovetail, according to some embodiments.

FIG. 4B is a schematic perspective view illustration of a mixing blade with an attachment mechanism including a tapered dovetail, according to some embodiments.

FIG. 5 is a schematic front view of a blade tip including a tapered dovetail, according to some embodiments.

FIG. 6 is a schematic perspective view illustration of a mixing blade with an attachment mechanism including a tension cable, according to some embodiments.

FIG. 7A is a schematic perspective view illustration of a portion of a mixing blade with an attachment mechanism including a notched multi-piece dovetail including a blade tip, according to some embodiments.

FIG. 7B is a schematic perspective view illustration of a portion of a mixing blade with an attachment mechanism including a notched multi-piece dovetail, according to some embodiments.

FIG. 8 is a schematic top view illustration of a mixing blade including a cast-in-place blade tip, according to some embodiments.

FIG. 9 is a schematic perspective view of a mixing apparatus, according to some embodiments.

FIG. 10 is a flowchart method of mixing an electrode film mixture, according to some embodiments.

FIG. 11 is a flowchart method of replacing a mixing blade tip, according to some embodiments.

### DETAILED DESCRIPTION

The present disclosure relates to mixing blades having a modular dual material construction to improve wear resistance, reduce contamination of mixed materials, reduce blade replacement time, and reduce blade replacement cost.

Generally described, one or more aspects of the present disclosure relate to mixing blades including a replaceable mixing blade tip and an attachment element. The replaceable mixing blade tip can be resistant to wear and easily replaced. The mixing blade can be utilized to mix an electrode film mixture (e.g., dry electrode film mixture), wherein the mixing apparatus can be configured to rotate one or more mixing blades around an axis. In some embodiments, the mixing blades can high shear mix the components of the dry electrode film mixture, which can generate abrasion and erosion on the mixing blade—particularly at the blade tip. As such, the replaceable mixing blade tip may be formed from an abrasion and erosion resistant material. The replaceable mixing blade tip can improve the wear resistance of the mixing blade and reduce the time and cost of replacing worn components.

### Mixing Blades

Mixing blades can be affixed to a mixing apparatus via a hub passing through the mixing blade. The mixing blade can be bi-directional with blade body extending in two directions from the hub or extend in a single direction from the hub. In some embodiments, the base blade includes a single arm extending in one direction from the hub. In some embodiments, the base blade includes a plurality of arms extending from the hub. For example, the base blade can include at least or at least about 1, 2, 3, 4, 5, or 6 arms. In some embodiments, each or any number of arms can have a blade tip at its end.

The mixing blades can spin at high velocities to high shear mix the components of an electrode film mixture (e.g., dry electrode film mixture). To protect the mixing blade from abrasion and erosion caused by the high shear mixing process, the highest wear portions of the mixing blade can be replaced with wear-resistant interchangeable blade tips. The highest wear portions are often concentrated at the tip of each arm and along the leading edge of the mixing blade away from the hub. Advantageously, attaching a blade tip to the base blade allows the blade tip to be replaceable, formed from an abrasion and/or erosion resistant material, and/or, reduce the overall blade weight.

In some embodiments, the blade tip extends from the leading edge to the trailing edge of the base blade. In some embodiments, the blade tip extends to an apex of the leading edge. In some embodiments, the blade tip extends over the leading edge of the base blade. In some embodiments, the blade tip extends over a portion of the leading edge of the base blade. In some embodiments, the blade tip shape is such that the blade tip is swept back.

The blade tips can attach to the base blade with an attachment element. In some embodiments, the attachment element includes fasteners for attaching the blade tips to the base blade. The fasteners can include bolts, nuts, pins, studs, posts deformable dowel pins, or press fit pins, and combinations thereof. In some embodiments, the blade tips are pressed onto the base blades via a mechanical interference fit. In some embodiments, the blade tips can attach to the base blade via a tapered dovetail connection. In some embodiments, the blade tips can attach to the base blade via a tension cable. In some embodiments, the blade tips can attach to the base blade via a notched dovetail. In some embodiments, the blade tips can be cast into the base blade. In some embodiments, the base blade can be cast into the blade tips. In some embodiments, the fasteners attaching the blade tips to the base blades via a dowel pin which has an interference fit with the blade tips and the base blades. In some embodiments, the blade tips attach to the base blades via a thermal interference fit where the blade tip is assembled to the base blade aided by thermal expansion or contraction. In some embodiments, the blade tips are welded or brazed onto the attachment element of the base blade. In some embodiments, the blade tips are 3D printed onto the base blade. In some embodiments, the blade tips attach to the base blade with adhesive. In some embodiments, adhesive aids in attaching the blade tips to the base blade.

In some embodiments, the base blade includes a material selected from a steel, stainless steel (e.g., 304 SS, 321 alloy, or 316L alloy), and combinations thereof. In some embodiments, the blade tips include an abrasion resistant material. In some embodiments, the blade tips include a material selected from a carbide (e.g., solid carbide), a steel, and combinations thereof. In some embodiments, a carbide material is selected from a tungsten carbide (e.g., grade KAR85 tungsten carbide composite, grade K701 tungsten carbide composite, grade CNC68 tungsten carbide composite). Advantageously, in some embodiments a solid carbide blade tip is highly resistant to wear, replaceable, and reduces the weight of the blade compared to a solid carbide blade. In some embodiments, the blade tip material has a compressive strength greater than 3000 MPa. In some embodiments, the blade tip compressive strength is, is about, is greater than, or is greater than about 2000 MPa, 2500 MPa, 3000 MPa, 3500 MPa, 4000 MPa, 4500 MPa, 5000 MPa, or any range of values therebetween. In some embodiments, the blade tip compressive strength is about, is greater than, or is greater than about 500 MPa, 600 MPa, 700 MPa, 800 MPa, 900 MPa, 1000 MPa, 1100 MPa, 1200 MPa, 1300 MPa, 1400 MPa, 1500 MPa, or any range of values therebetween. In some embodiments, the blade tip material has a volume loss wear rate at 90-degree impact (i.e., erosion) is, is about, is less than or is less than about 5 mm³, 4 mm³, 3 mm³, 2 mm³, 1.5 mm³, 1 mm³, 0.5 mm³, or any range of values therebetween. In some embodiments, the blade tip material has a volume loss wear rate at 22.5-degree impact (i.e., mainly abrasion) is, is about, is less than or is less than about 3.2 mm³, 3 mm³, 2.8 mm³, 2.4 mm³, 2.2 mm³, 2 mm³, 1.8 mm³, 1.6 mm³, 1.4 mm³, 1.2 mm³, 1 mm³, 0.8 mm³ or 0.6 mm³, or any range of values therebetween.

In some embodiments, the blade tips and/or on the leading edges of the right and left arms of the base blade include a coating. In some embodiments, the spray coating is positioned over at least one of a leading edge of the blade tip, and a leading edge of the base blade. In some embodiments, the coating is a spray coating. In some embodiments, the coating is a low friction coating. In some embodiments, the coating is a rubber coating. In some embodiments, the coating is a Teflon coating. In some embodiments, the coating is a carbide coating, for example Jet Kote™ 112 and Jet Kote™ 120. In some embodiments, the coating is polytetrafluoroethylene (PTFE).

### Fastener Mixing Blade

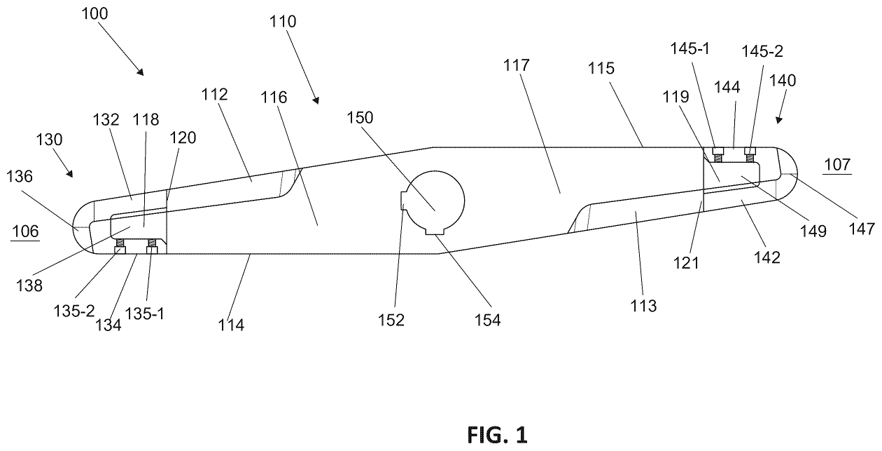

FIG. 1 illustrates an embodiment of a mixing blade 100. The mixing blade 100 includes a base blade 110, a left blade tip 130 positioned at a left end 106 of the mixing blade 100 and a right blade tip 140 positioned at a right end 107 of the mixing blade 100. As illustrated, the mixing blade 100 is configured to rotate clockwise.

The base blade 110 includes a hub 150 positioned equidistant from the left end 106 and the right end 107. The hub 150 is substantially circular and extends through the base blade 110. The hub 150 includes a first keyway 152 positioned on a left side of the hub 150 and a second keyway 154 positioned 90 degrees counterclockwise around the hub 150 from the first keyway 152. The base blade 110 includes a left arm 116 which extends from the hub 150 towards the left end 106. A left leading edge 112 is positioned on the left arm 116. The base blade 110 includes a right arm 117 which extends from the hub 150 towards the right end 107. A right leading edge 113 is positioned on the right arm 117. The left leading edge 112 and the right leading edge 113 are arranged for clockwise rotation. Each of the left leading edge 112 and the right leading edge 113 is chamfered to form a blade angle. The left arm 116 includes a left trailing edge 114 and the right arm 117 includes a right trailing edge 115. The left trailing edge 114 and right trailing edge 115 are arranged for clockwise rotation.

The left arm 116 terminates with a planar surface 120, and an attachment element 118 protrudes towards the left end 106 from the surface 120. As illustrated, the attachment element 118 tappers and has a wide end at the planar surface 120 and a narrow end towards the left end 106.

The right arm 117 terminates with a planar surface 121, and an attachment element 119 protrudes from the planar surface 120 towards the right end 107. As illustrated, the attachment element 119 tappers and has a wide end at the planar surface 121 and a narrow end towards the right end 107.

The left blade tip 130 includes recess 138 which engages with the attachment element 118 of the left arm 116. The left blade tip 130 includes a tip 136 at the point closest to the left end 106 and abuts the planar surface 120 opposite from the tip 136. The left blade tip 130 includes a leading edge 132 which aligns with the leading edge 112 of the base blade 110 and a trailing edge 134 which aligns with the trailing edge 114 of the base blade 110. The left blade tip 130 includes a first bolt thru-hole 135-1 and a second bolt thru-hole 135-2 positioned along the trailing edge 134. A first bolt can be positioned within the first bolt thru-hole 135-1 and a second bolt can be positioned within the second bolt thru-hole 135-2. Each of the bolts can thread into the attachment element 118. In some embodiments, the fasteners can include bolts, nuts, pins, studs, posts deformable dowel pins, or press fit pins, and combinations thereof.

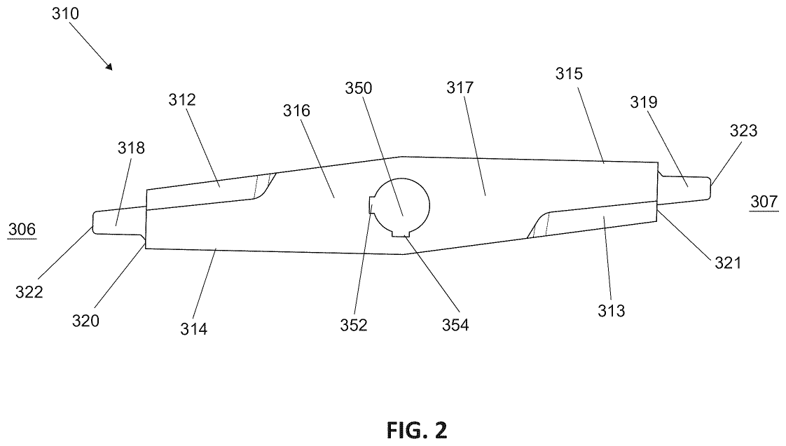

The right blade tip 140 includes recess 149 which engages with the attachment element 119 of the right arm 117. The right blade tip 140 includes a tip 147 at the point closest to the right end 107 and abuts the planar surface 121 opposite from the tip 147. The left blade tip 140 includes a leading edge 142 which aligns with the leading edge 113 of the base blade 110 and a trailing edge 144 which aligns with the trailing edge 115 of the base blade 110. The right blade tip 140 includes a first bolt thru-hole 145-1 and a second bolt thru-hole 145-2 positioned along the trailing edge 144. A first bolt can be positioned within the first bolt thru-hole 145-1 and a second bolt can be positioned within the second bolt thru-hole 145-2. Each of the bolts can thread into the attachment element 119. FIG. 2 illustrates an example of a base blade 310. The base blade 310 includes a hub 350 positioned equidistant from a left end 306 and a right end 307. The hub 350 is substantially circular and extends through the base blade 310. The hub 350 includes a first keyway 352 positioned on a left side of the hub 350 and a second keyway 354 positioned 90 degrees counterclockwise around the hub 350 from the first keyway 352. The base blade 310 includes a left arm 316 which extends from the base blade 310 towards the left end 306 and a right arm 317 which extends from the base blade 310 towards the right end 307. A left leading edge 312 is positioned on the left arm 316 and a right leading edge 313 is positioned on the right arm 317. The left leading edge 312 and the right leading edge 313 are arranged for clockwise rotation. Each of the left leading edge 312 and the right leading edge 313 is chamfered to form a blade angle. The left arm 316 includes a left trailing edge 314 and the right arm 317 includes a right trailing edge 315. The left trailing edge 314 and right trailing edge 315 are arranged for clockwise rotation.

The base blade 310 includes a left arm 316 which extends towards the left end 306. The left arm 316 terminates with a planar surface 320. An attachment element 318 protrudes towards the left end 306 from the surface 320. As illustrated, the attachment element 318 tappers and has a wide end at the planar surface 320 and a narrow end 322 towards the left end 306.

The base blade 310 includes a right arm 317 which extends towards the right end 307. The right arm 317 terminates with a planar surface 321. An attachment element 319 protrudes from the planar surface 320 towards the right end 307. As illustrated, the attachment element 319 tappers and has a wide end at the planar surface 321 and a narrow end 323 towards the right end 307.

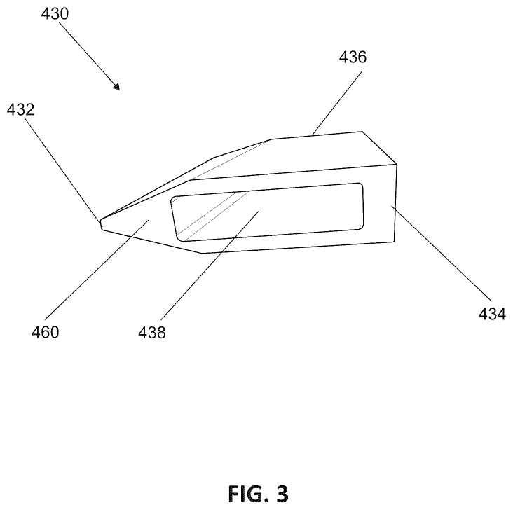

FIG. 3 illustrates an example of a blade tip 430. FIG. 3 is a perspective view into a recess 438 in the blade tip 430. The blade tip 430 includes a planar end surface 460 at a first end and a tip 436 at a second end. The recess 438 extends into the body of the blade tip 430 from the surface 460 towards the tip 436. The blade tip 430 includes a leading edge 432 positioned on a first side of the blade tip 430 and a trailing edge 434 positioned on a second side of the blade tip 430. The leading edge 432 has an asymmetric wedge shape, with a longer tapper on a first side and a shorter taper on a second side.

### Dovetail Mixing Blade

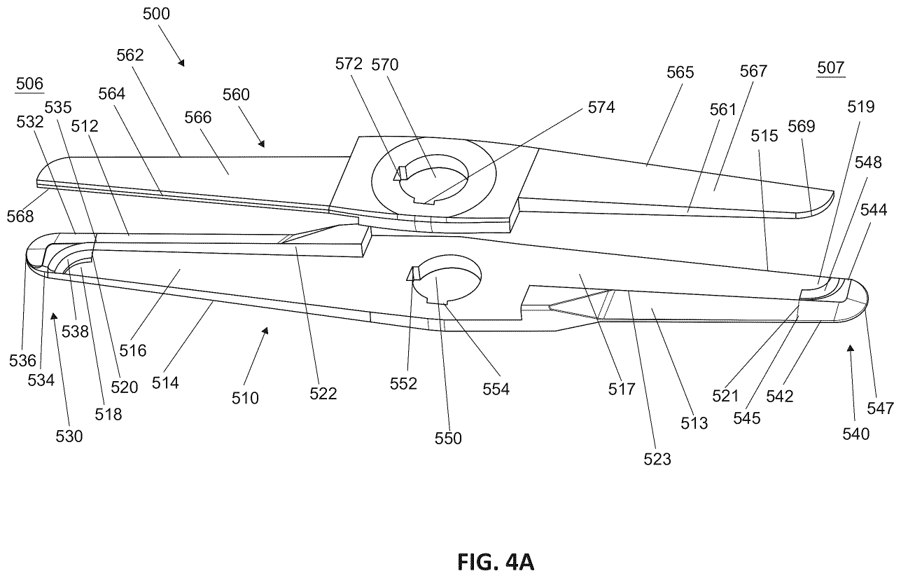

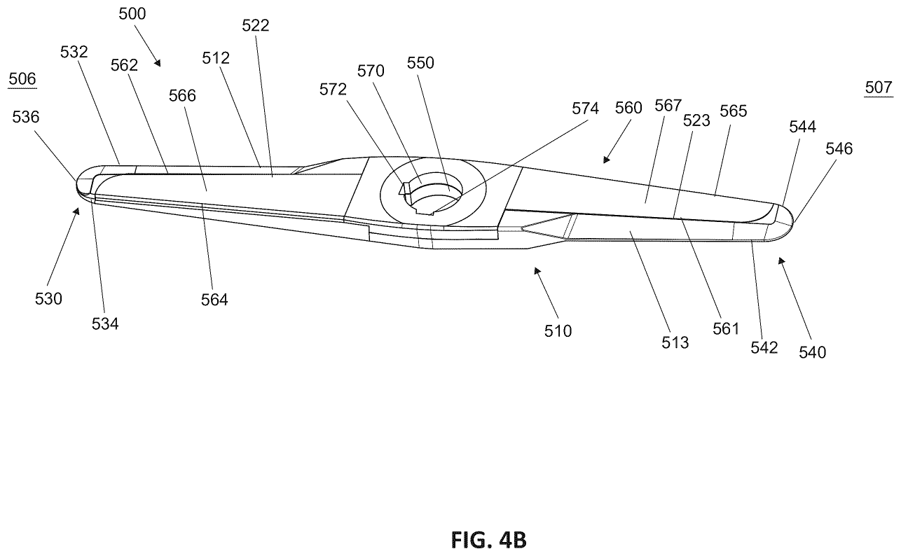

FIGS. 4A and 4B illustrate an example of a mixing blade 500. FIG. 4A illustrates an exploded perspective view of an example of a mixing blade 500 and FIG. 4B illustrates a perspective view of the example mixing blade 500. The mixing blade 500 includes a base blade 510, a blade tip 530 positioned at a left end 506 of the base blade 510, a blade tip 540 positioned at a right end 507 of the base blade 510, and a top blade 560 positioned above the base blade 510.

The base blade 510 includes a hub 550 positioned equidistant from the left end 506 and the right end 507. The hub 550 is circular and extends through the base blade 510. The hub 550 includes a first keyway 552 positioned on a left side of the hub 550 and a second keyway 554 positioned 90 degrees counterclockwise around the hub 550 from the first keyway 552. The base blade 510 includes a left arm 516 which extends from the base blade 510 towards the left end 506 and a right arm 517 which extends from the base blade 510 towards the right end 507. The left arm 516 includes a left leading edge 512 and the right arm 517 includes a right leading edge 513. The left leading edge 512 and the right leading edge 513 are arranged for clockwise rotation. Each of the left leading edge 512 and the right leading edge 513 is chamfered to form a blade angle. The base blade 510 includes a left centering face 522 inset from the left leading edge 512. The left centering face 522 extends the length of left leading edge 512. The base blade 510 includes a right centering face 523 inset from the right leading edge 513. The right centering face 523 extends the length of the right leading edge 513. The base blade 510 includes a left trailing edge 514 and a right trailing edge 515. The left trailing edge 514 and right trailing edge 515 are arranged for clockwise rotation.

The base blade 510 includes a left arm 516 which extends towards the left end 506. The left arm 516 terminates with a planar surface 520. An attachment element 518 is positioned towards the left end 506 from the surface 520. As illustrated, the attachment element 518 is a dovetail inset into the left arm 516.

The base blade 510 includes a right arm 517 which extends towards the right end 507. The right arm 517 terminates with a planar surface 521. An attachment element 519 is positioned towards the right end 507 of the right arm 517. As illustrated, the attachment element 519 is a tapered dovetail inset into the right arm 517.

The top blade 560 includes a hub 570 positioned equidistant from the left end 506 and the right end 507. The hub 570 is circular and extends through the top blade 560. The hub 570 includes a first keyway 572 positioned on a left side of the hub 570 and a second keyway 574 positioned 90 degrees counterclockwise around the hub 570 from the first keyway 572. The hub 570 has substantially the same radius, first keyway 572 size and positions, and second keyway 574 size and position as the hub 550. The top blade 560 includes a left centering face 562 which is positioned on a left top arm 566 facing the left leading edge 512. The top blade 560 includes a right centering face 561 which is positioned on a right top arm 567 facing the right leading edge 513. The left centering face 562 and right centering face 561 are shaped so that when the top blade 560 is place over the base blade 510 the left centering face 522 is positioned against the left centering face 562 and the right centering face 523 is positioned against the right centering face 561. When the left centering face 562 is positioned against the left centering face 522 and the right centering face 561 is positioned against the right centering face 523 the keyway 572 aligns with the keyway 552 and the keyway 574 aligns with the keyway 554. The top blade 560 includes a left trailing edge 564 and a right trailing edge 565. The left trailing edge 564 and right trailing edge 565 are arranged for clockwise rotation.

The left arm 566 of the top blade 560 extends towards the left end 506. An attachment element 568 is positioned towards the left end 506. As illustrated, the attachment element 568 is a dovetail inset into the left arm 566.

The right arm 567 of the top blade 560 extends towards the right end 507. An attachment element 569 is positioned towards the right end 507. As illustrated, the attachment element 569 is a dovetail inset into the right arm 567.

The blade tip 530 includes a planar end surface 535 at a first end and positioned against the surface 520 and a tip 536 at an end opposite from the planar end surface 535 and at the left end 506. A tapered dovetail 538 has an upper taper and a lower taper. The lower taper is a complementary shape to the attachment element 518. The upper taper is a complementary shape to the attachment element 568. The upper taper and lower taper curve away from a leading edge 532. The base blade 510 and the top blade 560 sandwich around the blade tip 530, thereby holding the blade tip 530 in place. The leading edge 532 is positioned on a first side of the blade tip 530 and a trailing edge 534 positioned on a second side of the blade tip 530. The leading edge 532 has an asymmetric wedge shape, with a longer tapper on a first side and a shorter taper on a second side. The leading edge 532 aligns with the shape of the leading edge 512 of the base blade 510.

The blade tip 540 includes a planar end surface 545 at a first end and positioned against the surface 521 and a tip 547 at an end opposite from the planar end surface 545 and at the right end 507. A tapered dovetail 548 has an upper taper and a lower taper. The lower taper is a complementary shape to the attachment element 519. The upper taper is a complementary shape to the attachment element 569. The upper taper and lower taper curve away from a leading edge 542. The base blade 510 and the top blade 560 sandwich around the blade tip 530, thereby holding the blade tip 530 in place. The leading edge 542 is positioned on a first side of the blade tip 540 and a trailing edge 544 is positioned on a second side of the blade tip 540. The leading edge 542 has an asymmetric wedge shape, with a longer tapper on a first side and a shorter taper on a second side. The leading edge 542 aligns with the leading edge 513 of the base blade 510.

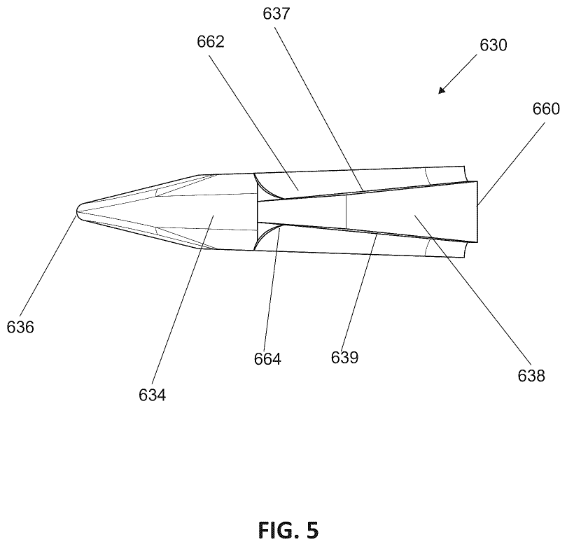

FIG. 5 illustrates a front view of a blade tip 630. The blade tip 630 includes a trailing edge 634, a tip 636, a planar face 660 positioned opposite from the tip 636, and a tapered dovetail 638 positioned between the tip 636 and the planar face 660. The tapered dovetail 638 includes a top face 637, a top curved face 662, a bottom face 639, and a bottom curved face 664. The tapered dovetail 638 is narrower towards the tip 636 and wider towards the planar face 660 with the top face 637 angled upward from the edge closest to the tip 636 to the planar face 660 and the bottom face 639 angled downward the edge closest to the tip 636 to the planar face 660. The tapered dovetail 638 is inset into the blade tip 630 and the top curved face 662 and the bottom curved face 664 transition the top face 637 and the bottom face 639 to the blade tip 630.

### Tension Cable Mixing Blade

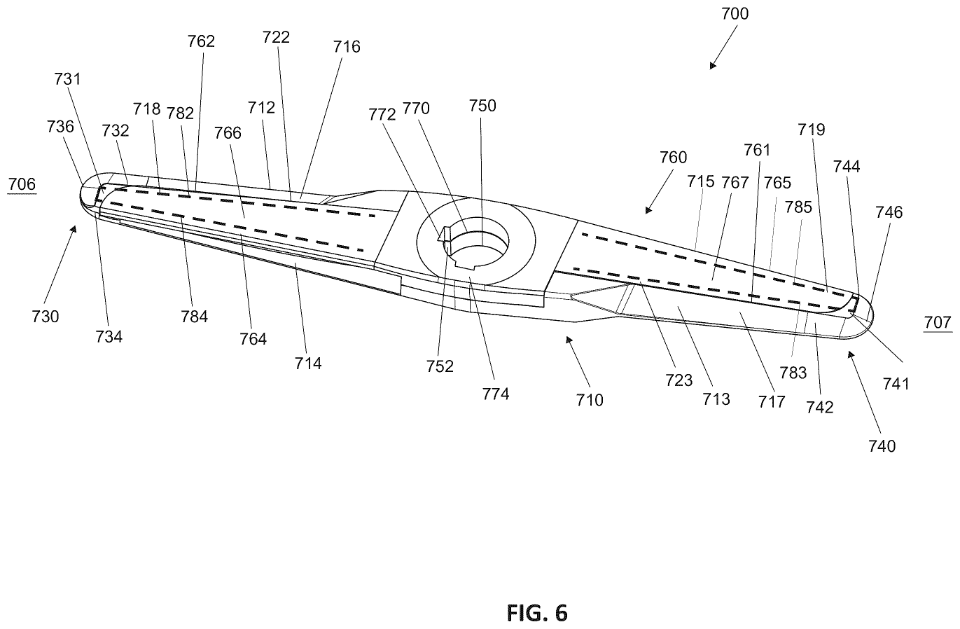

FIG. 6 illustrates a perspective view of an example of a mixing blade 700. The mixing blade 700 includes a base blade 710, a blade tip 730 positioned at a left end 706 of the base blade 710, a blade tip 740 positioned at a right end 707 of the base blade 710, and a top blade 760 positioned above the base blade 710.

The base blade 710 includes a hub 750 positioned equidistant from the left end 706 and the right end 707. The hub 750 is circular and extends through the base blade 710. The hub 750 includes a first keyway 752 positioned on a left side of the hub 750 and a second keyway (not visible) positioned 90 degrees counterclockwise around the hub 750 from the first keyway 752. The base blade 710 includes a left leading edge 712 and a right leading edge 713. The left leading edge 712 and the right leading edge 713 are arranged for clockwise rotation. Each of the left leading edge 712 and the right leading edge 713 is chamfered to form a blade angle. The base blade 710 includes a left centering face 722 inset from the left leading edge 712. The left centering face 722 extends the length of left leading edge 712. The base blade 710 includes a right centering face 723 inset from the right leading edge 713. The right centering face 723 extends the length of the right leading edge 713. The base blade 710 includes a left trailing edge 714 and a right trailing edge (not visible). The left trailing edge 714 and right trailing edge (not visible) are arranged for clockwise rotation.

The base blade 710 includes a left arm 716 which extends towards the left end 706. An attachment element 718 is inset within the base blade 710. As illustrated, the attachment element 718 is a tension cable.

The base blade 710 includes a right arm 717 which extends towards the right end 707. An attachment element 719 is positioned towards the right end 707 of the right arm 717. As illustrated, the attachment element 719 is a tension cable.

The top blade 760 includes a hub 770 positioned equidistant from the left end 706 and the right end 707. The hub 770 is circular and extends through the top blade 760. The hub 770 includes a first keyway 772 positioned on a left side of the hub 770 and a second keyway 774 positioned 90 degrees counterclockwise around the hub 770 from the first keyway 772. The hub 770 has substantially the same radius, first keyway 772 size and position, and second keyway 774 size and position as the hub 750. The top blade 760 includes a left centering face 762 which is positioned on a left top arm 766 facing the left leading edge 712. The top blade 760 includes a right centering face 761 which is positioned on a right top arm 767 facing the right leading edge 713. The left centering face 762 and right centering face 761 are shaped so that when the top blade 760 is place over the base blade 710 the left centering face 722 is positioned against the left centering face 762 and the right centering face 723 is positioned against the right centering face 761. When the left centering face 762 is positioned against the left centering face 722 and the right centering face 761 is positioned against the right centering face 723 the keyway 772 aligns with the keyway 752 and the keyway 774 aligns with the second keyway (not visible). The top blade 760 includes a left trailing edge 764 and a right trailing edge 765. The left trailing edge 764 and right trailing edge 765 are arranged for clockwise rotation.

The blade tip 730 includes an internal channel 731 through which the attachment element 718 is routed. The internal channel 731 loops through the blade tip 730. The leading edge 732 is positioned on a first side of the blade tip 730 and a trailing edge 734 positioned on a second side of the blade tip 730. The leading edge 732 has an asymmetric wedge shape, with a longer tapper on a first side and a shorter taper on a second side. The leading edge 732 aligns with the leading edge 712 of the base blade 710. The blade tip 730 also includes a blade tip 736.

The blade tip 740 includes an internal channel 741 through which the attachment element 719 is routed. The internal channel 741 loops through the blade tip 740. The leading edge 742 is positioned on a first side of the blade tip 740 and a trailing edge 744 is positioned on a second side of the blade tip 740. The leading edge 742 has an asymmetric wedge shape, with a longer tapper on a first side and a shorter taper on a second side. The leading edge 742 aligns with the leading edge 713 of the base blade 710. The blade tip 740 also includes a blade tip 746.

The attachment element 718 (e.g., the tension cable) passes through an internal channel 782 in the base blade 710 inset from the leading edge 712 and a second internal channel 784 in the base blade 710 inset from the trailing edge 714.

The attachment element 719 (e.g., the tension cable) passes through an internal channel 783 in the base blade 710 inset from the leading edge 713 and a second internal channel 785 in the base blade 710 inset from the trailing edge 715.

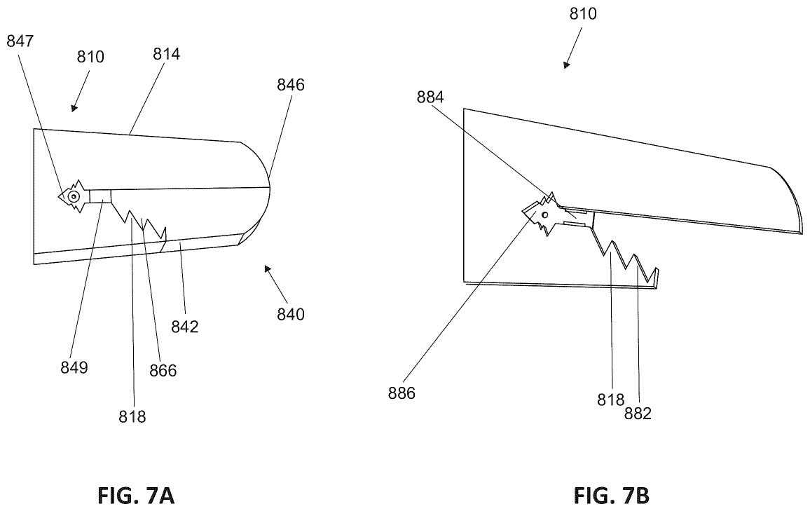

FIG. 7A illustrates a perspective view of an example of a blade tip 840 attached to a portion of a base blade 810. FIG. 7B illustrates a perspective view of an example of a portion of a base blade 810. The base blade 810 includes an attachment element 818. The attachment element 818 is a multi-part dovetail including a notched dovetail 882, a keyway slot 884, and a keyhole 886.

The blade tip 840 includes a tip 846, a leading edge 842, a pin (not visible), and a dovetail 866. The dovetail 866 is complementary with the notched dovetail 882. The dovetail 866 can slide vertically into the notched dovetail 882. A vertical keyway pin 849 fixes the vertical position of the blade tip 840 by engaging the pin (not visible) with keyway slot 884. The vertical keyway pin 849 further engages with horizontal rails of the keyway slot 884. A horizontal keyway pin 847 fixes the horizontal position of the vertical keyway pin 849. The horizontal keyway pin 847 engages with vertical rails positioned within the keyhole 886 stopping the vertical keyway pin 849 from sliding out of its position engaged against the blade tip 840. The horizontal keyway pin 847 includes a through-hole. A screw can pass through the through-hole and engage with threads in the keyhole 886.

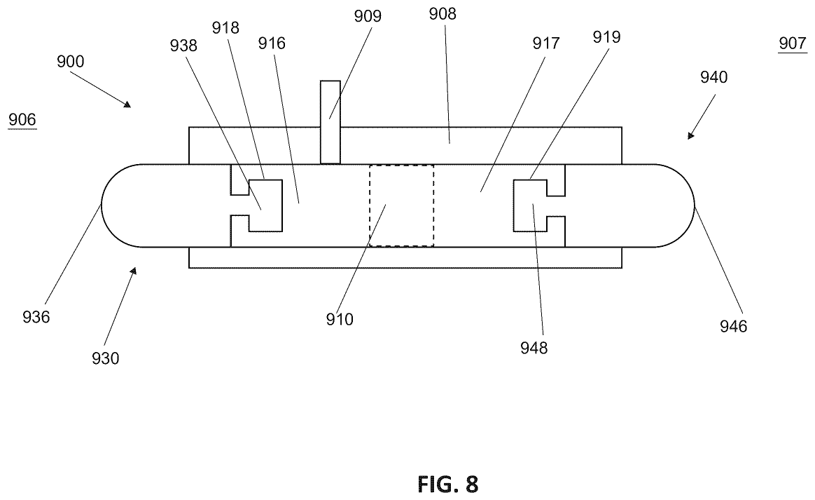

FIG. 8 illustrates a top view of an example of a mixing blade 900. As illustrated, the mixing blade 900 includes a cast base blade 910, a left blade tip 930, and a right blade tip 940. The base blade 910 includes a left arm 916 and a right arm 917. The left arm 916 includes an attachment element 918. The right arm 917 includes an attachment element 919. The left blade tip 930 includes a blade tip 936 positioned at the left end 906 of the mixing blade 900 and a t-shaped pin 938 positioned opposite from the blade tip 936. The right blade tip 940 includes a blade tip 946 positioned at the right end 907 of the mixing blade 900 and a t-shaped pin 948 positioned opposite from the blade tip 946.

As illustrated, the left blade tip 930 and the right blade tip 940 are fixed in place by a casting mold 908 and the material of the base blade 910 is poured into the casting mold 908 through a mold port 909 to form the base blade 910. The casting fixedly molds the pins 938 and 948 into the base blade 910 forming the attachment elements 918 and 919. The casting mold 908 can be removed from the mixing blade 900 prior to use.

In some embodiments, the base blade is molded into the blade tips. In some embodiments, material is molded into the blade tips which can be welded onto the base blade. In some embodiments, features are molded into the base blade to engage the blade tips.

### Mixers

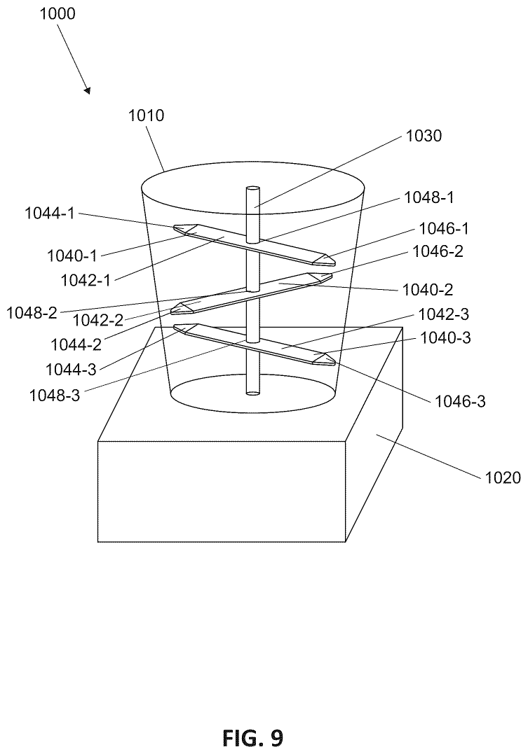

FIG. 9 is a perspective view of a mixing apparatus 1000. As illustrated, the mixing apparatus 1000 includes a mixing container 1010 and a mixing base 1020. A shaft 1030 extends through the mixing container 1010. As illustrated, three mixing blades 1040-1-1040-3 are attached to the shaft 1030.

Mixing blade 1040-1 includes a base blade 1042-1, a hub 1048-1 positioned at positioned equidistant from each end of the base blade 1042-1, a first blade tip 1044-1 positioned at a first end of the base blade 1042-1, and a second blade tip 1046-1 positioned at a second end of the base blade 1042-1.

Mixing blade 1040-2 includes a base blade 1042-2, a hub 1048-2 positioned at positioned equidistant from each end of the base blade 1042-2, a first blade tip 1044-2 positioned at a first end of the base blade 1042-2, and a second blade tip 1046-2 positioned at a second end of the base blade 1042-2.

Mixing blade 1040-3 includes a base blade 1042-3, a hub 1048-3 positioned at positioned equidistant from each end of the base blade 1042-3, a first blade tip 1044-3 positioned at a first end of the base blade 1042-3, and a second blade tip 1046-3 positioned at a second end of the base blade 1042-3.

The mixing container 1010 can be configured to hold an electrode film mixture within the volume defined within the mixing container 1010. The mixing base 1020 can include a motor which can drive the shaft 1030 to rotate the mixing blade 1040-1-1040-3. In some embodiments, the mixing apparatus 1000 can include, include about, or include at least about 1, 2, 3, 4, 5, 6, 7, 8, 9, 10 mixing blades or any range of mixing blades therebetween. In some embodiments, the mixing apparatus 1000 can be used to mix an electrode film mixture. In some embodiments, the mixing container 1010 includes an inlet and/or an outlet for material to enter and exit the mixing container 1010, respectively. In some embodiments, the mixing container 1010 further includes a fluidized bed mixer.

### Methods of Using and Replacing Mixing Blades and Mixers

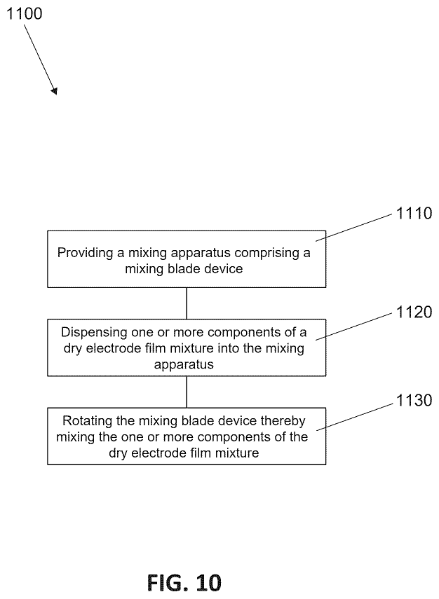

FIG. 10 illustrates a method 1100 of mixing an electrode film mixture. At step 1110, the method includes a mixing apparatus comprising a mixing blade device as described herein. At step 1120, the method includes dispensing one or more components of a dry electrode film mixture into the mixing apparatus. At step 1130, the method includes rotating the mixing blade device thereby mixing the one or more components of the dry electrode film mixture.

In some embodiments, the method includes processing a dry non-fibrillizable binder at high shear to form a dry microparticulate non-fibrillizable binder, combining a dry fibrillizable binder with the dry microparticulate non-fibrillizable binder to form a dry electrode film mixture, and calendering the dry electrode film mixture to form a free-standing dry electrode film. In some embodiments, the method includes providing a dry microparticulate non-fibrillizable binder, mixing the dry microparticulate non-fibrillizable binder with a dry first active material via the mixing apparatus to form a dry bulk active material mixture, mixing a dry fibrillizable binder with a second dry active material by a high shear mixing process to form a dry structural binder mixture, mixing the dry bulk active material mixture and the dry structural binder mixture by a second nondestructive mixing process to form a dry electrode film mixture, and producing a free standing dry electrode film from the dry electrode film mixture. In some embodiments, the method includes processing a dry non-fibrillizable binder at high shear via the mixing apparatus to form the dry microparticulate non-fibrillizable binder. In some embodiments, a high shear process may cause fibrillization of binder material, or otherwise form a binder/active material matrix to assist in forming a self-supporting electrode film.

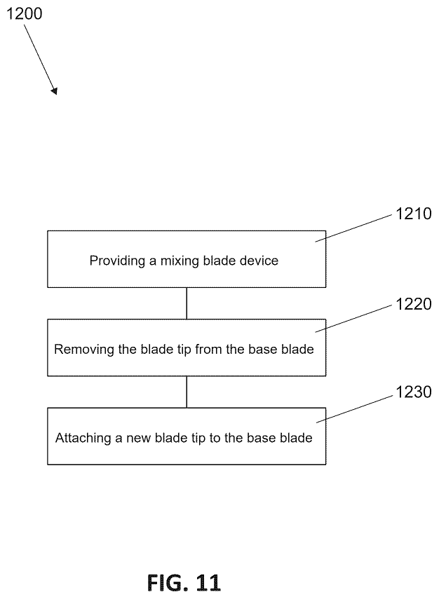

FIG. 11 illustrates a method 1200 of replacing a mixing blade tip. At step 1210, the method includes providing a mixing blade device as described herein. At step 1220, the method includes removing the blade tip from the base blade. At step 1230, the method includes attaching a new blade tip to the base blade.

### Electrode Materials, Electrode Films, Electrodes and Energy Storage Devices

An active material (e.g., cathode active material, anode active material) may be used in the preparation of an electrode film and/or electrode for an energy storage device. In some embodiments, an electrode comprises a current collector and an electrode film.

In some embodiments, the active material is a cathode active material. In some embodiments, the cathode active material is selected from at least one of a metal oxide, metal sulfide, a sulfur-carbon composite, a lithium metal oxide, and a material including sulfur. In some embodiments, the cathode active material is selected from lithium iron phosphate (i.e., LiFePO4 or “LFP”), lithium manganese iron phosphate (e.g., LiMn0.6Fe0.4PO4 or “LMFP”), lithium nickel manganese cobalt oxide (i.e., LiNixMnyCo1-x-yO2 or “NMC”), lithium nickel cobalt aluminum oxide (i.e., LiNixCoyAlzO2 or “NCA”), lithium manganese oxide (“LMO”), lithium nickel manganese oxide (“LNMO”), lithium cobalt oxide (“LCO”), lithium titanate (“LTO”), or combinations thereof. In some embodiments, the cathode active material includes at least two of LFP, LMFP, NMC, NCA, LMO, LNMO, LCO, LTO, and combinations thereof. In some embodiments, the cathode active material is an iron phosphate-based active material. In some embodiments, iron phosphate-based active materials include LiFePO4 (i.e., “lithium iron phosphate” and “LFP”) and LiMn1-xFexPO4 (i.e., “lithium manganese iron phosphate” and “LMFP”) (e.g., LiMn0.6Fe0.4PO4 or LiMn0.8Fe0.2PO4). In some embodiments, the iron phosphate-based active material includes LFP. In some embodiments, the iron phosphate-based active material includes an LMFP. In some embodiments, the iron phosphate-based active material includes an LFP and/or an LMFP.

In some embodiments, the active material is an anode active material. In some embodiments, anode active materials can include, for example, an insertion material (such as carbon, graphite, and/or graphene), an alloying/dealloying material (such as silicon, silicon oxide, tin, and/or tin oxide), a metal alloy or compound (such as Si—Al, and/or Si—Sn), and/or a conversion material (such as manganese oxide, molybdenum oxide, nickel oxide, and/or copper oxide). The anode active materials can be used alone or mixed together to form multi-phase materials (such as Si—C, Sn—C, SiOx—C, SnOx—C, Si—Sn, Si—SiOx, Sn—SnOx, Si—SiOx—C, Sn—SnOx—C, Si—Sn—C, SiOx—SnOx—C, Si—SiOx—Sn, or Sn—SiOx—SnOx.). Anode active materials include common natural graphite, synthetic or artificial graphite, surface modified graphite, spherical-shaped graphite, flake-shaped graphite and blends or combinations of these types of graphite, metallic elements and its compound as well as metal-C composite for anode.

In some embodiments, the electrode film mixture and/or electrode film comprises the active material in an amount of, of about, of at least, or at least about, 70 wt. %, 75 wt. %, 80 wt. %, 85 wt. %, 86 wt. %, 87 wt. %, 88 wt. %, 89 wt. %, 90 wt. %, 91 wt. %, 92 wt. %, 93 wt. %, 94 wt. %, 95 wt. %, 96 wt. %, 97 wt. %, 98 wt. %, 98.5 wt. %, 99 wt. %, 99.5 wt. %, 99.8 wt. % or 99.9 wt. %, or any range of values therebetween.

In some embodiments, the electrode film mixture and/or an electrode film comprises a carbon material configured to reversibly intercalate lithium ions. In some embodiments, the lithium intercalating carbon is selected from a graphitic carbon, graphite, hard carbon, soft carbon and combinations thereof. For example, the electrode film of the electrode can include a binder material, one or more of graphitic carbon, graphite, graphene-containing carbon, hard carbon and soft carbon, and an electrical conductivity promoting material. In some embodiments, an electrode is mixed with lithium metal and/or lithium ions. In some embodiments, the electrode comprises the carbon material in a total amount of, of about, of at most, or at most about, 20 wt. %, 15 wt. %, 10 wt. %, 9 wt. %, 8 wt. %, 7 wt. %, 6 wt. %, 5 wt. %, 4 wt. %, 3 wt. %, 2 wt. %, 1 wt. %, or any range of values therebetween.

In some embodiments, the electrode film mixture and/or an electrode film includes a conductive additive. In some embodiments, the conductive additive may comprise a conductive carbon additive, such as a carbon black. In some embodiments, the conductive additive may comprise a conductive carbon additive. In some embodiments, the conductive carbon additive comprises carbon black, carbon nanotubes, such as single-walled carbon nanotubes (SWCNTs) and multi-walled carbon nanotubes (MWCNTs). In some embodiments, the electrode film comprises the conductive additive in a total amount of, of about, of at most, or at most about, 10 wt. %, 9 wt. %, 8 wt. %, 7 wt. %, 6 wt. %, 5 wt. %, 4 wt. %, 3 wt. %, 2 wt. %, 1 wt. %, 0.5 wt. %, 0.25 wt. %, 0.1 wt. %, or any range of values therebetween. In some embodiments, each of the conductive additive is in an amount of, of about, of at most, or at most about, 10 wt. %, 9 wt. %, 8 wt. %, 7 wt. %, 6 wt. %, 5 wt. %, 4 wt. %, 3 wt. %, 2 wt. %, 1 wt. %, 0.5 wt. %, 0.25 wt. %, 0.1 wt. %, of the electrode film, or any range of values therebetween. In some embodiments, the conductive additive is carbon black.

In some embodiments, the electrode film mixture and/or the electrode film includes a binder. In some embodiments, binders can include polytetrafluoroethylene (PTFE), a polyolefin, polyalkylenes, polyethers, styrene-butadiene, co-polymers of polysiloxanes and polysiloxane, branched polyethers, polyvinylethers, a carboxymethylcellulose (CMC), co-polymers thereof, and/or combinations thereof. In some embodiments, the polyolefin can include polyethylene (PE), polypropylene (PP), polyvinylidene fluoride (PVDF), co-polymers thereof, and/or combinations thereof. For example, the binder can include polyvinylene chloride, poly(phenylene oxide) (PPO), polyethylene-block-poly(ethylene glycol), poly(ethylene oxide) (PEO), poly(phenylene oxide) (PPO), polyethylene-block-poly(ethylene glycol), polydimethylsiloxane (PDMS), polydimethylsiloxane-coalkylmethylsiloxane, co-polymers thereof, and/or combinations thereof. In some embodiments, the binder may include a thermoplastic. In some embodiments, the binder comprises a fibrillizable and/or fibrillized polymer. In certain embodiments, the binder comprises, consists essentially, or consists of a single fibrillizable and/or fibrillized binder, such as PTFE. In some embodiments, the electrode film includes, includes about, includes at most, or includes at most about, 1 wt. %, 2 wt. %, 3 wt. %, 4 wt. %, 5 wt. %, 6 wt. %, 7 wt. %, 8 wt. %, 9 wt. %, 10 wt. %, or any range of values therebetween, of a binder.

In some embodiments, the electrode film mixture and/or the electrode film can be a wet processed electrode film. In some embodiments, the electrode film is prepared by a wet or slurry-based electrode fabrication process. In some embodiments, the electrode film of the present disclosure can be a dry processed electrode film. In some embodiments, the electrode film is prepared by a dry electrode fabrication process. As used herein, a dry electrode fabrication process can refer to a process in which no or substantially no solvents are used to form a dry electrode film. For example, components of the active layer or electrode film, including carbon materials and binders, may comprise, consist of, or consist essentially of dry particles. The dry particles for forming the active layer or electrode film may be combined to provide a dry particle active layer mixture. In some embodiments, the active layer or electrode film may be formed from the dry particle active layer mixture such that weight percentages of the components of the active layer or electrode film and weight percentages of the components of the dry particles active layer mixture are substantially the same. In some embodiments, the active layer or electrode film formed from the dry particle active layer mixture using the dry fabrication process may be free from, or substantially free from, any processing additives such as solvents and solvent residues resulting therefrom. In some embodiments, the resulting active layer or electrode films are self-supporting films formed using the dry process from the dry particle mixture. In some embodiments, the resulting active layer or electrode films are free-standing films formed using the dry process from the dry particle mixture. A process for forming an active layer or electrode film can include fibrillizing the fibrillizable binder component(s) such that the film comprises fibrillized binder. In further embodiments, a free-standing active layer or electrode film may be formed in the absence of a current collector. In still further embodiments, an active layer or electrode film may comprise a fibrillized polymer matrix such that the film is self-supporting. It is thought that a matrix, lattice, or web of fibrils can be formed to provide mechanical structure to the electrode film.

In some embodiments, an electrode film is disposed on a current collector (e.g., a coated lane is disposed on a foil layer) to form an electrode. In some embodiments, a current collector can include a metallic material, such as a material comprising aluminum, nickel, copper, combinations of the foregoing. In some embodiments, a current collector comprises a pure metal. In some embodiments, a current collector comprises a metallized polymer film or metal coated polymer film. In some embodiments, the polymer comprises polyethylene terephthalate (PET), biaxially oriented polypropylene (BOPP) or a combination thereof. In some embodiments, the metal coating comprises aluminum. In some embodiments, coating the final electrode film mixture comprises forming a uniform electrode film mixture coating. In some embodiments, the current collector comprises a thickness of, of about, of at most, or at most about, 200 μm, 100 μm, 50 μm, 40 μm, 30 μm, 20 μm, 15 μm, 10 μm, 5 μm, or any range of values therebetween.

In some embodiments, an electrode is a double-sided electrode. In some embodiments, the double-sided electrode includes two electrode films. In some embodiments, the double-sided electrode may include a current collector, a top electrode film, and a bottom electrode film. In some embodiments, each of the two electrode films can have any suitable shape, size and thickness.

In some embodiments, an energy storage device comprises a separator, an anode electrode, the cathode electrode, an electrolyte, and a housing, wherein the electrolyte, separator, anode electrode and cathode electrode are disposed within the housing and the separator is positioned between the anode and cathode electrodes. In some embodiments, an energy storage device is formed by placing an electrolyte, a separator, an anode electrode and the cathode electrode described herein within a housing, wherein the separator is placed between the anode electrode and the cathode electrode.

An electrode assembly includes a cathode, an anode, and a separator positioned between the anode and cathode. In some embodiments, the electrode assembly is a wound electrode (i.e., rolled electrode) assembly (e.g., a jelly roll). In some embodiments, the energy storage device is selected from the group consisting of a cylindrical energy storage device, a stacked prismatic energy storage device, and a spiral-wound prismatic energy storage device.

The electrode disclosed herein may be used for an energy storage device. In some embodiments, the energy storage device comprises a separator, an anode electrode, the cathode electrode, an electrolyte, and a housing, wherein the electrolyte, separator, anode electrode and cathode electrode are disposed within the housing and the separator is positioned between the anode and cathode electrodes. In some embodiments, an energy storage device is formed by placing an electrolyte, a separator, an anode electrode and the cathode electrode described herein within a housing, wherein the separator is placed between the anode electrode and the cathode electrode. In some embodiments, the energy storage device comprises an anode electrode positioned between two cathode electrodes. In some embodiments, the anode electrode and/or the cathode electrode comprises a shaped electrode film. In some embodiments, the energy storage device is a lithium-ion battery. In some embodiments, the energy storage devices may be a battery, capacitor, capacitor-battery hybrid, fuel cell, or combinations thereof. In some embodiments, the energy storage system or energy storage device may be used for electromobility. In some embodiments, the energy storage device may be used in motor vehicles, including hybrid electric vehicles (HEV), plug-in hybrid electric vehicles (PHEV), and/or electric vehicles (EV). In some embodiments, the energy storage device used in motor vehicles, including hybrid electric vehicles (HEV), plug-in hybrid electric vehicles (PHEV), and/or electric vehicles (EV) reduces greenhouse gas emissions.

In some embodiments, the energy storage device is charged with a suitable lithium-containing electrolyte. For example, the energy storage device can include a lithium salt, and a solvent, such as a non-aqueous or organic solvent. Generally, the lithium salt includes an anion that is redox stable. In some embodiments, the anion can be monovalent. In some embodiments, a lithium salt can be selected from lithium hexafluorophosphate (LiPF6), lithium bis(trifluoromethanesulfonyl)imide (LiFSI), lithium tetrafluoroborate (LiBF4), lithium perchlorate (LiClO4), lithium bis(trifluoromethansulfonyl)imide (LiN(SO2CF3)2), lithium trifluoromethansulfonate (LiSO3CF3), lithium bis(oxalato)borate (LiB(C2O4)2), lithium bis(fluorosulfonyl)imide (LiN(SO2F)2, lithium difluoro(oxalato)borate (LiC2BF2O4) and combinations thereof. In some embodiments, the electrolyte can include a quaternary ammonium cation and an anion selected from the group consisting of hexafluorophosphate, tetrafluoroborate and iodide. In some embodiments, the salt concentration can be about 0.1 mol/L (M) to about 5 M, about 0.2 M to about 3 M, or about 0.3 M to about 2 M. In further embodiments, the salt concentration of the electrolyte can be about 0.7 M to about 2 M. In certain embodiments, the salt concentration of the electrolyte can be about 0.2 M, about 0.3 M, about 0.4 M, about 0.5 M, about 0.6 M, about 0.7 M, about 0.8 M. about 0.9 M, about 1 M, about 1.1 M, about 1.2 M, 1.3M, 1.4M, 1.5M or values therebetween.

In some embodiments, an energy storage device can include a liquid solvent. The solvent need not dissolve every component, and need not completely dissolve any component, of the electrolyte. In further embodiments, the solvent can be an organic solvent. In some embodiments, a solvent can include one or more functional groups selected from dioxathiolane (e.g., 1,3,2-dioxathiolane-2,2-dioxide (i.e., “DTD”)), carbonates, ethers and/or esters. In some embodiments, the solvent can comprise a carbonate. In further embodiments, the carbonate can be selected from cyclic carbonates such as, for example, ethylene carbonate (EC), propylene carbonate (PC), vinyl ethylene carbonate (VEC), vinylene carbonate (VC), fluoroethylene carbonate (FEC), and combinations thereof, or acyclic carbonates such as, for example, dimethyl carbonate (DMC), diethyl carbonate (DEC), ethyl methyl carbonate (EMC), 1,3-propene sultone (PRS), and combinations thereof. In some embodiments, the solvent can comprise an ester. In some embodiments, the ester is selected from methyl acetate (MA), methyl propionate (MP), ethyl acetate (EA), methyl butyrate (MB), and combinations thereof. In some embodiments, the solvent may include EC, PC, VEC, VC, FEC, DMC, DEC, EMC, MA, MP, EA, MB, and combinations thereof. In some embodiments, the solvent may include EC, DMC, DEC, EMC, MA, and combinations thereof. In some embodiments, the solvent may include EC, DMC, EMC, and combinations thereof. In some embodiments, the solvent may include a ratio of EC: DMC: EMC of 10-30: 0-90: 0-70.

In some embodiments, one or more solvents can be used at a concentration of, of about, of at least, or at least about, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. % or 90 wt. %, or any range of values therebetween. In some embodiments, solvents are utilized as additives in the electrolyte system, and can be used at a concentration of, of about, of at most, or at most about, 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2 wt. %, 2.1 wt. %, 2.2 wt. %, 2.3 wt. %, 2.4 wt. %, 2.5 wt. %, 2.6 wt. %, 2.7 wt. %, 2.8 wt. %, 2.9 wt. %, 3 wt. %, 4 wt. %, 5 wt. %, 6 wt. %, 7 wt. %, 8 wt. %, 9 wt. % or 10 wt. %, or any range of values therebetween. For example, in some embodiments, the amount of an additive in the electrolyte is or is about in any one of the following ranges: 0.1-10 wt. %, 1-6 wt. %, 2-5 wt. %, 0.1-6 wt. %, 2-8 wt. %, 2-3 wt. %, or 1-4 wt. %.

In some embodiments, an energy storage device is created such that one electrode (e.g., anode) is larger than and overhangs the other electrode (e.g., cathode). One electrode may overhang the other in the winding direction and/or non-winding direction of the electrode assembly. Such electrode overhangs may avoid yield losses. In some embodiments where there is no, or is substantially no, overlap and/or intermingling of the separator and the shaped electrode film (e.g., cathode electrode film), the boundary of the shaped electrode film is easier to identify and therefore improves the ability to form a counter electrode (e.g., anode electrode) with an overhang.

The foregoing disclosure is not intended to limit the present disclosure to the precise forms or embodiments disclosed herein. As such, it is contemplated that various alternative forms, embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed battery system. It is to be understood that the forms of disclosure herein shown and described are to be taken as representative embodiments. Equivalent elements, or materials may be substituted for those representatively illustrated and described herein. Moreover, certain features of the disclosure may be utilized independently of the use of other features, all of which is apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense and should in no way be construed as limiting of the present disclosure. All joinder references (e.g., connected, associated, coupled, and the like) are only used to aid the reader's understanding of the present disclosure, and may not create limitations, particularly as to the position, orientation, or use of the elements disclosed herein. Therefore, joinder references, if any, are to be construed broadly. Moreover, such joinder references may not necessarily infer that two elements are directly connected to each other.

Additionally, all numerical terms, such as, but not limited to, “first”, “second”, “one”, “another”, or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed in certain cases, as is useful in accordance with a particular application.

For expository purposes, the term “horizontal” as used herein is defined as a plane parallel to the plane or surface of the floor of the area in which the device being described is used or the method being described is performed, regardless of its orientation. The term “floor” can be interchanged with the term “ground.” The term “vertical” refers to a direction perpendicular to the horizontal as just defined. Terms such as “above,” “below,” “bottom,” “top,” “side,” “front,” “rear,” “lateral,” “higher,” “lower,” “upper,” “over,” and “under,” are defined with respect to the horizontal plane, in use.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Although certain embodiments and examples have been described herein, it will be understood by those skilled in the art that many aspects of the systems shown and described in the present disclosure may be differently combined and/or modified to form still further embodiments or acceptable examples. All such modifications and variations are intended to be included herein within the scope of this disclosure. A wide variety of designs and approaches are possible. No feature, structure, or step disclosed herein is essential or indispensable.

For purposes of this disclosure, certain aspects, advantages, and novel features are described herein. It is to be understood that not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Moreover, while illustrative embodiments have been described herein, the scope of any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to the examples described in the present specification or during the prosecution of the application, which examples are to be construed as non-exclusive. Further, the actions of the disclosed processes and methods may be modified in any manner, including by reordering actions and/or inserting additional actions and/or deleting actions. It is intended, therefore, that the specification and examples be considered as illustrative only, with a true scope and spirit being indicated by the claims and their full scope of equivalents.

Conditional language used herein, such as, among others, “can,” “might,” “may,” “e.g.,” and the like, unless specifically stated otherwise, or otherwise understood within the context as used, is generally intended to convey that some embodiments include, while other embodiments do not include, certain features, elements, and/or states. Thus, such conditional language is not generally intended to imply that features, elements, blocks, and/or states are in any way required for one or more embodiments or that one or more embodiments necessarily include logic for deciding, with or without author input or prompting, whether these features, elements and/or states are included or are to be performed in any particular embodiment.

The ranges disclosed herein also encompass any and all overlap, sub-ranges, and combinations thereof. Language such as “up to,” “at least,” “greater than,” “less than,” “between,” and the like includes the number recited.

What is claimed is:

1. A mixer comprising:
a dry electrode film mixture comprising an active material and a carbon material;
a mixing blade comprising:
a base blade comprising a steel base material, and a first leading edge and extending in a first direction;
a solid carbide blade tip positioned at an end of the base blade and extending over a portion of the first leading edge; and
an attachment element configured to removably attach the solid carbide blade tip to the base blade; and
a mixing container, wherein the dry electrode film mixture and the mixing blade are positioned within the mixing container;
wherein the mixing blade is configured to high shear process the dry electrode film mixture.

2. A mixing blade device, comprising:
a base blade comprising a base material;
a blade tip, comprising a wear-resistant material; and
an attachment element configured to attach the blade tip to the base blade;
wherein the base material is different than the wear-resistant material.

3. The mixing blade device of claim 2, wherein the wear-resistant material comprises solid carbide.

4. The mixing blade device of claim 3, wherein the base material comprises steel.

5. The mixing blade device of claim 2, wherein the attachment element is selected from the group consisting of a pin, a post, a bolt, a dovetail, a tensioning element, and combinations thereof.

6. The mixing blade device of claim 2, wherein the base blade further comprises the attachment element.

7. The mixing blade device of claim 2, wherein the base blade further comprises an upper blade portion and a lower blade portion.

8. The mixing blade device of claim 7, wherein the attachment element is positioned between the upper blade portion and the lower blade portion.

9. The mixing blade device of claim 2, wherein the wear-resistant material has a compressive strength greater than 4000 MPa.

10. The mixing blade device of claim 2, wherein the wear-resistant material has a yield strength of greater than 1200 MPa.

11. The mixing blade device of claim 2, wherein a blade tip material volume loss wear rate at 90-degree impact (i.e., erosion) is less than about 2 mm³.

12. The mixing blade device of claim 2, wherein a blade tip material volume loss wear rate at 22.5-degree impact is less than about 1 mm³.

13. A mixing blade device, comprising:
a base blade comprising a base material;
a first blade tip disposed at a first end of the base blade;
a first attachment element configured to attach the first blade tip to the base blade;
a second blade tip disposed at a second end of the base blade; and
a second attachment element configured to attach the second blade tip to the base blade.

14. The mixing blade device of claim 13, wherein the first blade tip and the second blade tip comprise a wear-resistant material comprising solid carbide.

15. The mixing blade device of claim 13, further comprising a spray coating.

16. The mixing blade device of claim 15, wherein the spray coating is positioned over at least one of a leading edge of the first blade tip, the second blade tip, and a leading edge of the base blade.

17. A method of replacing a mixing blade tip, the method comprising:
providing the mixing blade device of claim 2;
removing the blade tip from the base blade; and
attaching a new blade tip to the base blade.

18. A method of mixing an electrode film mixture, the method comprising:
providing a mixing apparatus comprising the mixing blade device of claim 2;
dispensing one or more components of a dry electrode film mixture into the mixing apparatus; and
rotating the mixing blade device thereby mixing the one or more components of the dry electrode film mixture.

19. A mixing apparatus, the apparatus comprising:
one or more mixing blade devices of claim 2; and
a mixer.

20. The mixing apparatus of claim 19, wherein the mixer is a fluidized bed mixer.
